(19) United States
(12) Patent Application Publication
(10) Pub. No.: US 2020/0056074 A1
(43) Pub. Date: Feb. 20, 2020

(54) ADHESIVE SHEET

(71) Applicant: SHARP KABUSHIKI KAISHA, Sakai City (JP)

(72) Inventor: JUN MAEDA, Sakai City (JP)

(21) Appl. No.: 16/529,768

(22) Filed: Aug. 1, 2019

Related U.S. Application Data
(60) Provisional application No. 62/719,775, filed on Aug. 20, 2018.

(51) Int. Cl. C09J 7/40

(52) U.S. Cl. CPC C09J 7/40

(57) ABSTRACT

An adhesive sheet includes a base, an adhesive layer, and a first peeling sheet. The base has a sheet shape. The adhesive layer is disposed on the base. The first peeling sheet is disposed on a surface of the adhesive layer opposite to the base. The first peeling sheet is configured to be able to be peeled from the adhesive layer while being wound in a predetermined direction. The first peeling sheet includes an overlap region, an extended portion, and slits. The overlap region overlaps the adhesive layer in a plan view. The extended portion sticks out from the overlap region. The slits in the extended portion extend in a direction that crosses a winding direction of the first peeling sheet. The slits are arranged at intervals along the winding direction.

### CROSS REFERENCE TO RELATED APPLICATION

This application claims priority from U.S. Provisional Patent Application No. 62/719,775 filed on Aug. 20, 2018. The entire contents of the priority application are incorporated herein by reference.

The technology described herein relates to an adhesive sheet.

### BACKGROUND ART

As an example of an adhesive sheet of the related art characterized in a peeling sheet, there has been known an adhesive sheet described in Japanese Unexamined Patent Application Publication No. 2007-233189 listed below. The adhesive sheet includes a belt-shaped label sheet body provided with an adhesive layer and a belt-like peeling sheet stacked on top of the belt-shaped label sheet body by being stuck to the adhesive layer, and the belt-shaped peeling sheet has a picking tab that sticks out from an edge of the belt-shaped label sheet body in a width direction. Further, such a belt-shaped peeling sheet has a slit in a region thereof that is stuck to the adhesive layer. Such a configuration makes it possible to easily peel the belt-shaped peeling sheet from the belt-shaped label sheet body. Specifically, in peeling the belt-shaped peeling sheet, picking the picking tab with a thumb disposed on the picking tab and an index finger disposed on the slit and raising the picking tab with the index finger twisted causes the slit to open, so that the slit is easily peeled from a portion of the belt-shaped label sheet body to which the slit is stuck. This peeling serves as a trigger to further peeling.

An attempt to peel the peeling sheet by winding it up with an automatic winder such as a roller instead of manually winding it up may result in failure of further peeling, depending on the configuration disclosed in Patent Document 1. When the peeling sheet is low in bendability, e.g. in a case where the peeling sheet has a certain degree of thickness, peeling starts from the slit, but the peeling sheet cannot follow the rotation of the roller, with the undesirable result that there is no further peeling.

### SUMMARY

The technology described herein was made in view of the above circumstances. An object is to improve the peelability of a peeling sheet.

An embodiment of the technology described herein is directed to an adhesive sheet including a base having a sheet shape; an adhesive layer disposed on the base; and a first peeling sheet disposed on a surface of the adhesive layer opposite to the base, wherein the first peeling sheet is configured to be able to be peeled from the adhesive layer while being wound in a predetermined direction, the first peeling sheet includes an overlap region that overlaps the adhesive layer in plan view, an extended portion that sticks out from the overlap region, and slits in the extended portion and extending in a direction that crosses a winding direction of the first peeling sheet, and the slits are arranged along the winding direction.

The present invention makes it possible to improve the peelability of a peeling sheet.

### BRIEF DESCRIPTION OF THE DRAWINGS

FIG. 1 is a bottom view of an adhesive sheet according to Embodiment 1 of the technology described herein.

FIG. 2 is a cross-sectional view taken along line 11-II in FIG. 1.

FIG. 3 is a diagram showing modifications of slits of FIG. 2.

FIG. 4 is a side view showing an operation of carrying in an adhesive sheet in a combining step.

FIG. 5 is a side view showing an operation of peeling a first peeling sheet in the combining step.

FIG. 6 is a diagram showing how a roller is stuck to the first peeling sheet.

FIG. 7 is a diagram showing how the roller peels the first peeling sheet by rotating.

FIG. 8 is another diagram showing how the roller peels the first peeling sheet by rotating.

FIG. 9 is a diagram showing how the roller has wound up the first peeling sheet by rotating.

FIG. 10 is a diagram showing how the roller has unwound the first peeling sheet by rotating backward.

FIG. 11 is a side view showing an operating of carrying in a touch panel in the combining step.

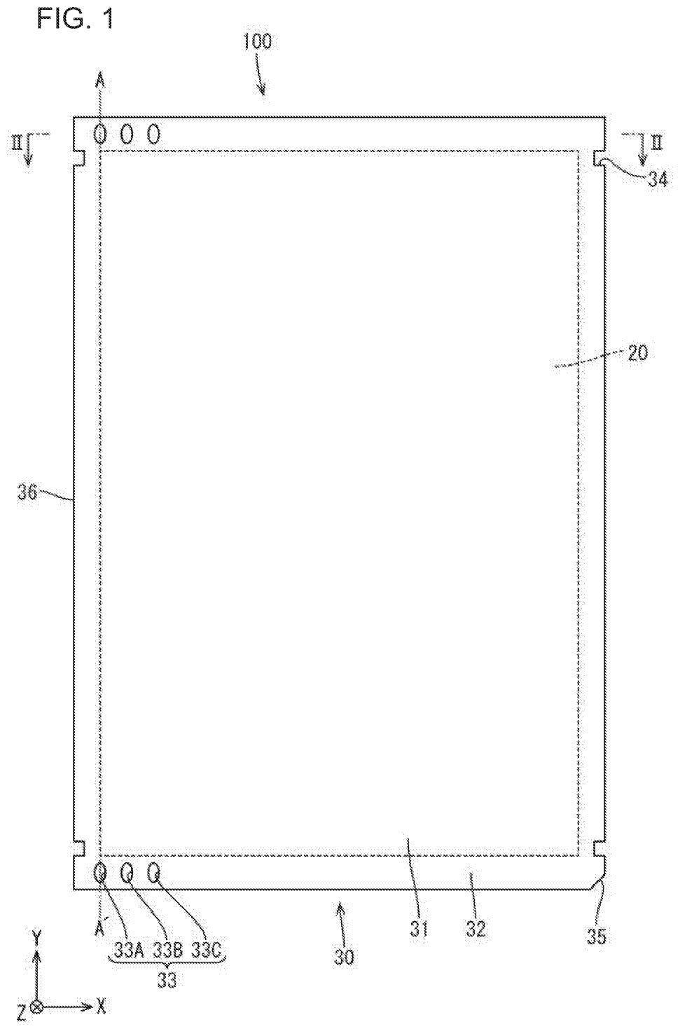

FIG. 1.2 is a side view showing an operating of bonding the touch panel and an adhesive layer together in the combining step.

### DETAILED DESCRIPTION

### Embodiment 1

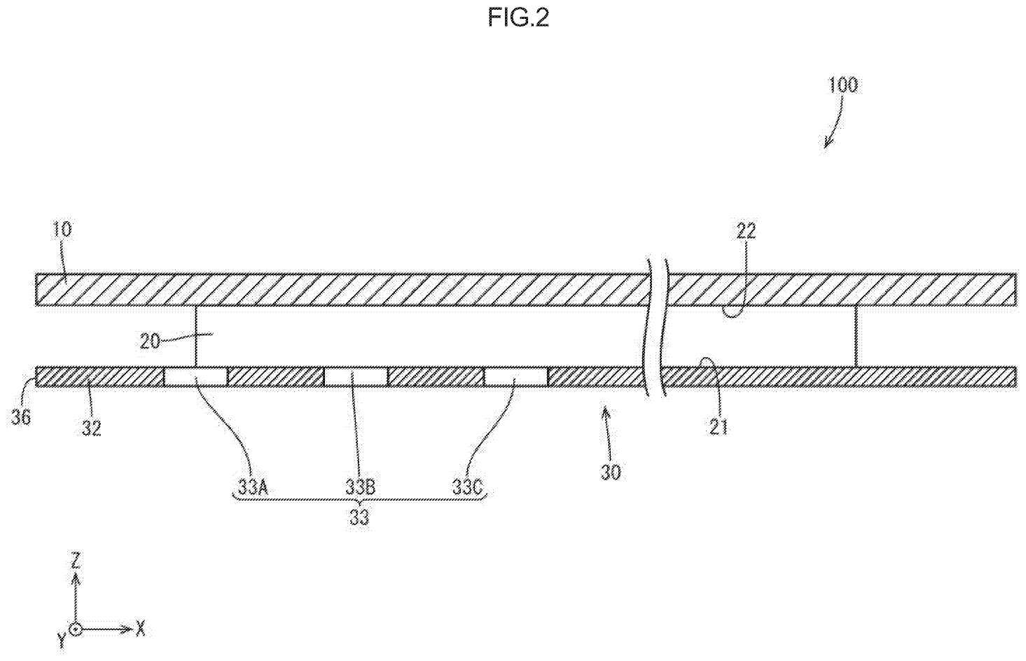

Embodiment 1 of the technology described herein is described with reference to FIGS. 1 and 2. The present embodiment illustrates an adhesive sheet 100. It should be noted that some of the drawings show an X axis, a Y axis, and a Z axis and are drawn so that the direction of each axis is an identical direction in each drawing.

As shown in the plan view (bottom view) of FIG. 1, the adhesive sheet 100 has a vertically long rectangular shape (rectangular shape) as a whole, and this adhesive sheet 100 has its short side direction corresponding to an X-axis direction of each drawing, its long side direction corresponding to a Y-axis direction of each drawing, and its thickness direction corresponding to a Z-axis direction. As shown in the cross-sectional view of FIG. 2, the adhesive sheet 100 includes a base 10 having a sheet shape, an adhesive layer 20, disposed on one surface of the base 10, that has adhesiveness, and a first peeling sheet 30, disposed on one of a pair of layer surfaces of the adhesive layer 20 opposite to the base 10, that has peelability. The adhesive sheet 100 is configured such that the first peeling sheet 30, the adhesive layer 20, and the base 10 are stacked on top of each other in this order from the bottom, and FIG. 1 corresponds to a view of the adhesive sheet 100 as seen from the first peeling sheet 30 at the bottom (underneath). The first peeling sheet 30 is stuck to the adhesive layer 20. Before use, the first peeling sheet 30 is peeled so that one surface (in FIG. 2, a lower surface 21) of the adhesive layer 20 is exposed. This brings the lower surface 21 of the adhesive layer 20 into a state of being able to adhere to an external adherend member.

The adhesive layer 20 has a rectangular shape as indicated by dotted lines in FIG. 1. The adhesive layer 20 has its thickness selected as appropriate from a range of approximately 10 μm to 500 μm according to the purpose for which it is used. In particular, as will be described later, in a case where the adhesive layer 20 is used for combining a display panel, the adhesive layer 20 has, in addition to adhesiveness, transparency that allows the display panel to be seen through the adhesive layer 20.

The base 10 is a sheet that protects the adhesive layer 20, and has a planar shape that conforms to the adhesive layer 20. The base 10 may also have peelability and, in the present embodiment, constitutes a second peeling sheet made of synthetic resin such as PET (polyethylene terephthalate). The base 10 (second peeling sheet) is formed to be larger in planar size than the adhesive layer 20, and by turning over a portion of the base 10 that sticks out from the adhesive layer 20, the base 10 is easily peeled from the adhesive layer 20. Once the base 10 is peeled, an upper surface 22 of the adhesive layer 20 is exposed, so that the upper surface 22 thus exposed becomes able to adhere to an external adherend member. That is, the adhesive sheet 100 is configured such external adherend members can be bonded to both the front and back surfaces of the adhesive sheet 100, respectively. For example, by bonding, to the front and back of the adhesive sheet 100, a display panel that displays an image and a touch panel through which to input positional information in a display surface of the display panel with the touch of a finger or the like, respectively, the display panel and the touch panel can be combined for use in an electronic device such as a smartphone.

The first peeling sheet 30 is made of synthetic resin, such as PET, that has peelability, and has a rectangular planar shape that conforms to the adhesive layer 20. For the same reason as the base 10, which constitutes the second peeling sheet, the first peeling sheet 30 is formed to be larger in planar size than the adhesive layer 20. As shown in FIG. 1, the first peeling sheet 30 has an overlap region 31, located in the center of the rectangular shape, which overlaps the adhesive layer 20 in plan view and an extended portion 32 that has a frame shape that surrounds the overlap region 31. The extended portion 32 sticks out from the overlap region 31 and the adhesive layer 20.

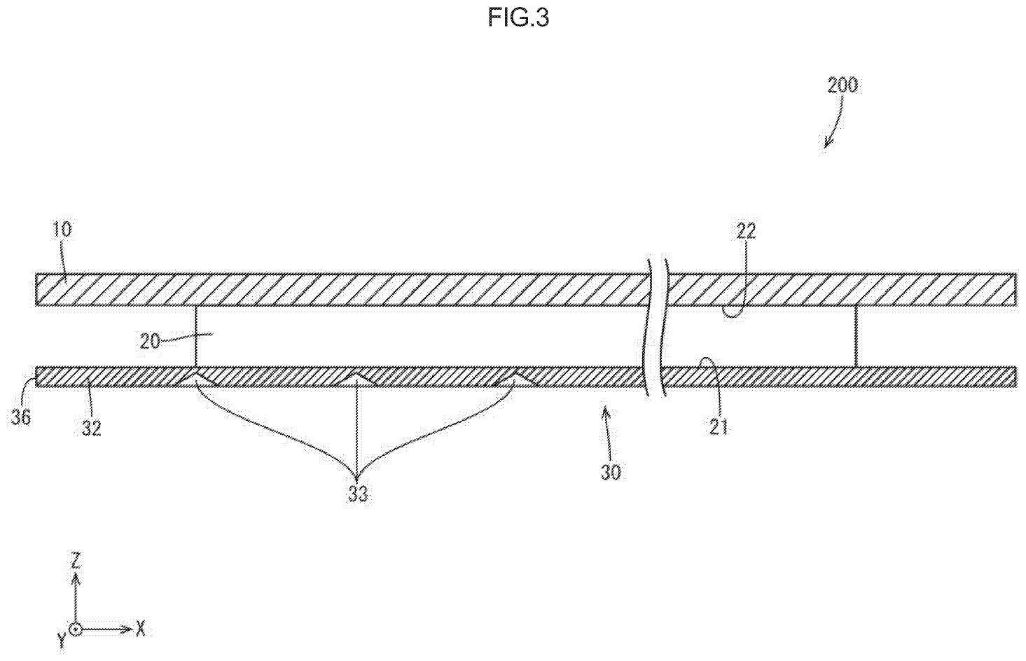

The extended portion 32 of the first peeling sheet 30 is provided with slits 33 that are openings bored through the extended portion 32 in a thickness direction, and the slits 33 have long and narrow shapes that extend along a long side direction (Y-axis direction). The slits 33 include a plurality of slits (in the present embodiment, three slits 33A, 33B, and 33C) arranged at regular intervals (in a row) along a short side direction (X-axis direction). The three slits 33A, 338, and 33C are identical in shape to one another. The slit 33A, which is one of the three slits 33A, 33B, and 33C, is disposed on the extension of a boundary between the adhesive layer 20, the overlap region 31, and the extended portion 32 (i.e. on line A-A′ in FIG. 1). Furthermore, the three slits 33A, 338, and 33C are provided in a pair on both of a pair of short sides of the extended portion 32. That is, as shown in FIG. 1, a pair of three slits 33 are disposed on the upper and lower short sides, respectively, of the extended portion 32. The term “slits” used herein does not necessarily refer to slits bored through the extended portion 32 but, as shown as a modification in an adhesive sheet 200 in FIG. 3, also encompasses grooves 330 cut into the extended portion 32 in a thickness direction (unless otherwise noted, the term “slits 33” hereinafter also encompasses the grooves 330 according to the modification).

As shown in FIG. 1, the first peeling sheet 30 also has a plurality of notches 34 formed in vertically and horizontally symmetrical places (in the present embodiment, four places) by cutting off parts of an outer edge of the first peeling sheet 30 and a chamfer 35 formed by cutting off one corner of the outer edge. In a case where the slits are opening 33 bored through the extended portion 32 in a thickness direction, the slits, i.e. the openings 33, can be formed by being cut out together with at least either the notches 34 or the chamfer 35 with trimming die. This brings about an advantage of easy manufacturability.

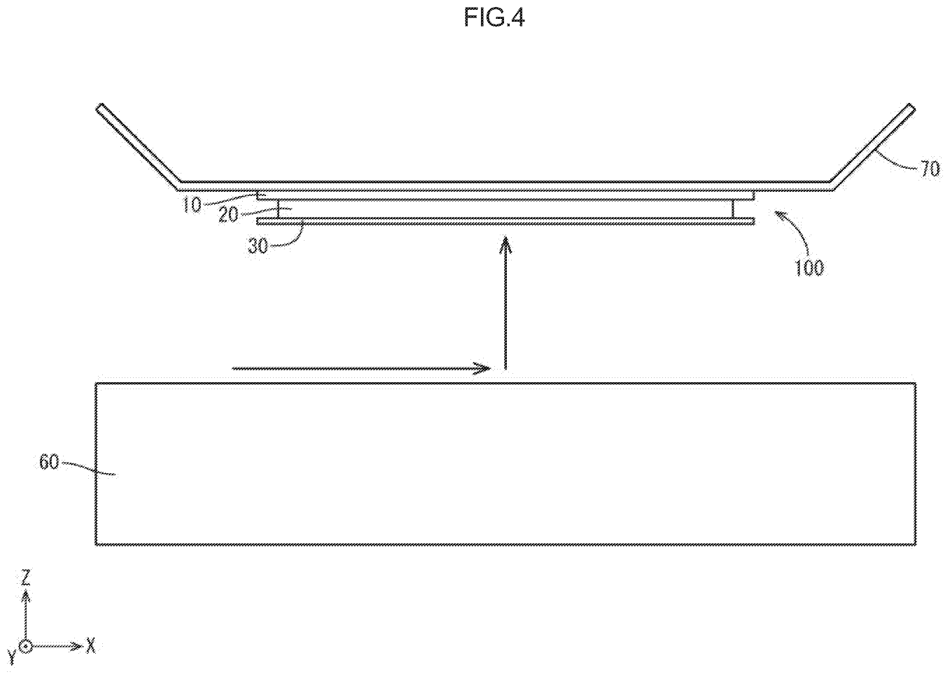

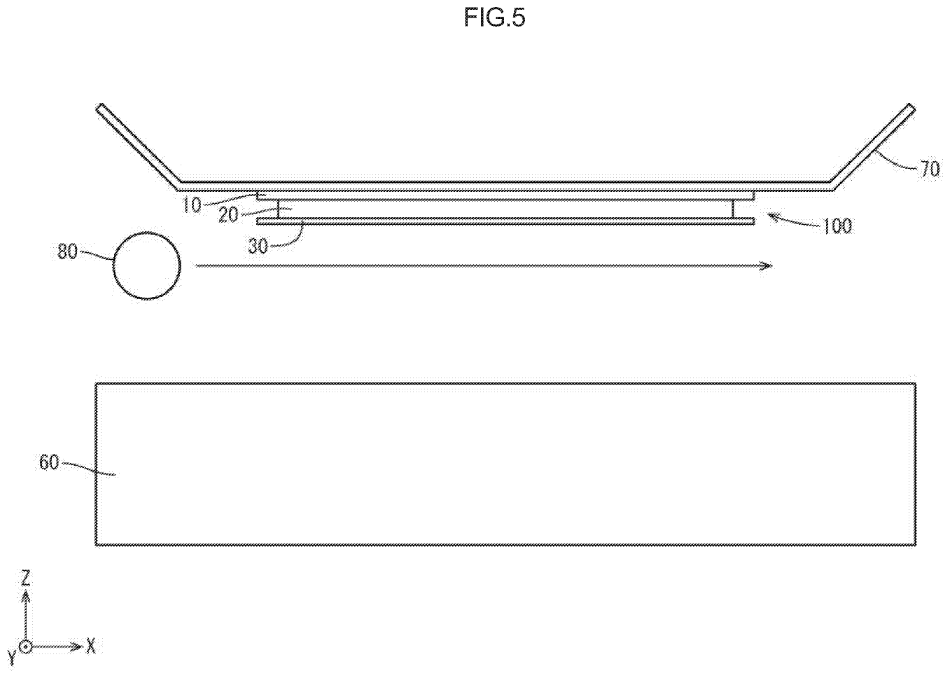

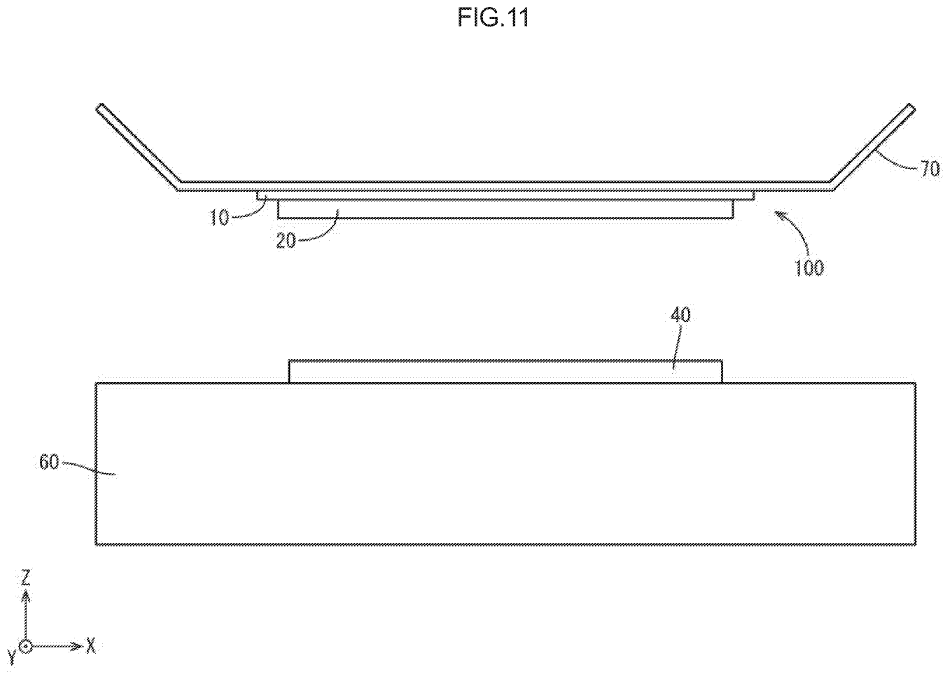

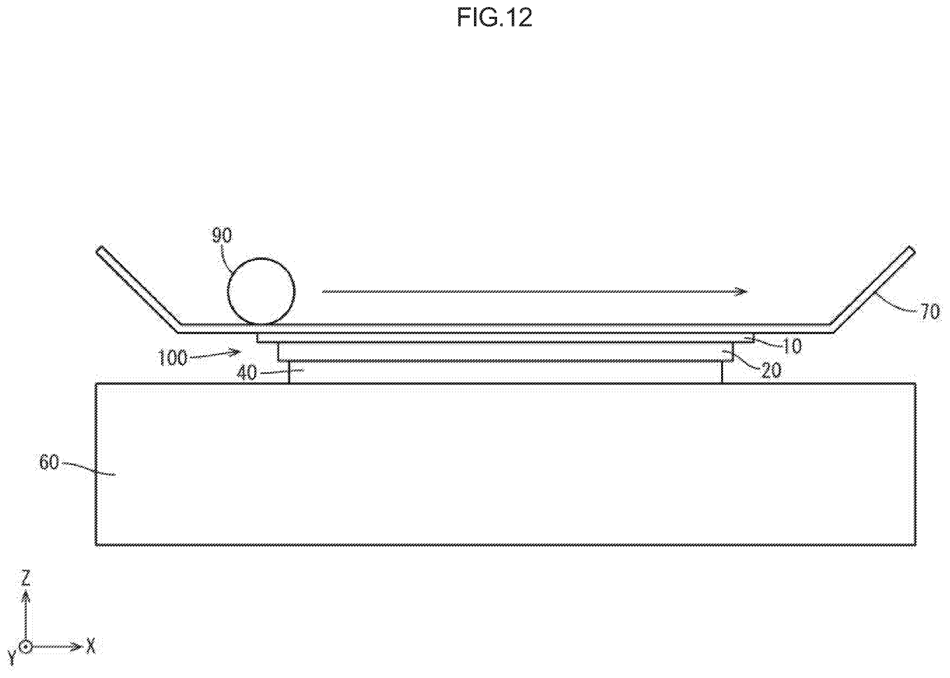

Next, usage patterns, workings, and effects of the adhesive sheet 100 according the embodiment described above are described with reference to FIGS. 4 to 12. The present usage pattern illustrates a combining step of combining the adhesive sheet 100 and a touch panel 40 with each other. The step of combining the adhesive sheet 100 and the touch panel 40 with each other includes four processing operations that are executed in sequence, namely an operation of carrying in the adhesive sheet 100 (FIG. 4), an operation of peeling the first peeling sheet 30 (FIGS. 5 to 10), an operation of carrying in the touch panel 40 (FIG. 11), and an operation of bonding the touch panel 40 and the adhesive layer 20 together (FIG. 12). In the present specific example, the touch panel 40 has a planar size of 6.5 inches, and the adhesive sheet 100 has a planar size (the adhesive layer measuring 89.9 mm×147.2 mm in outer dimension, the base 10 and the first peeling sheet 30 measuring 99.99 mm×161.2 mm in outer dimension) which corresponds to that of the touch panel 40. Further, as for the thickness of each layer of the adhesive sheet 100, the base 10, the adhesive layer 20, and the first peeling sheet 30 are 125 μm, 250 μm, and 75 μm thick, respectively.

In the operation of carrying in the adhesive sheet 100, as shown in FIG. 4, the adhesive sheet 100 is carried in onto a carry-in table 60 in such a position that its first peeling sheet 30 faces down, that its short side direction extends along the X axis, and that its long side direction extends along the Y axis. In so doing, by carrying in the adhesive sheet 100 so that the notches 34 and chamfer 35 of the first peeling sheet 30 are disposed in designated locations on the carry-in table 60, the front and back of the adhesive sheet 100 can be identified and the left, right, top and bottom of the adhesive sheet 100 can be positioned. This identification and this positioning may be made more efficient by using photographing means such as a camera. Next, in the same position as at the carry-in time, the adhesive sheet 100, which has been properly disposed on the carry-in table 60, is stuck by air suction to a movable pressure-bonding table 70 installed above the carry-in table 60. This causes the adhesive sheet 100 to be fixed to the pressure-bonding table 70 with the first peeling sheet 30 facing down.

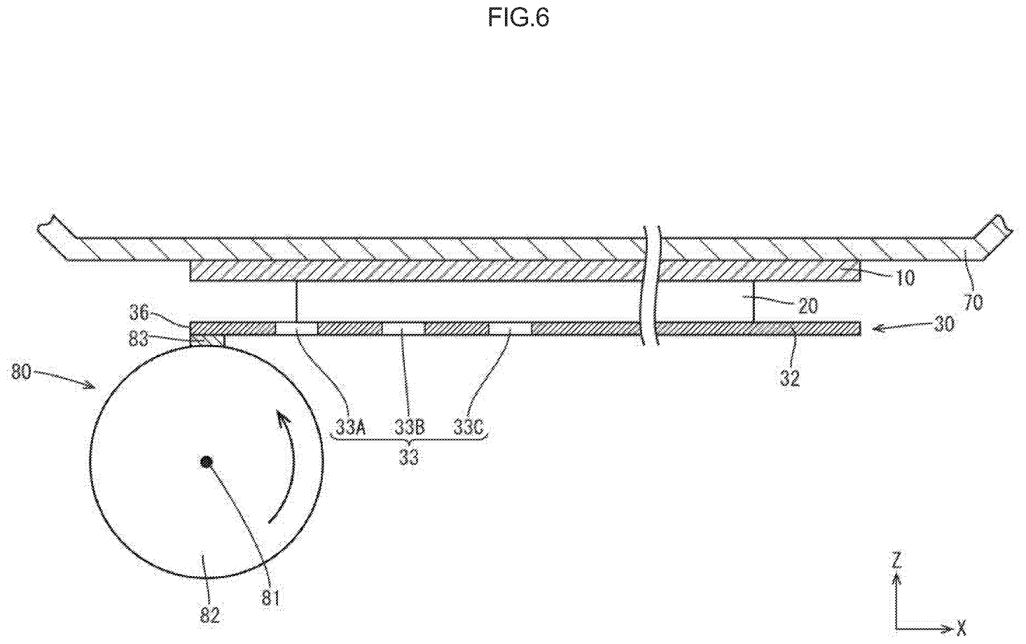

Next, in the operation of peeling the first peeling sheet 30, as shown in FIG. 5, the adhesive sheet 100, which has been fixed to the pressure-bonding table 70, the first peeling sheet 30 is peeled by being wound up by a roller 80, which is an automatic winder. Specifically, as shown in the chronological order of FIGS. 6 to 9, the roller 80 travels in the X-axis direction while winding up the first peeling sheet 30 by rotating in a given direction (in the present embodiment, counterclockwise). That is, the first peeling sheet 30 is peeled from the adhesive layer 20 while being wound in a predetermined direction (X-axis direction) by the roller 80 traveling in the X-axis direction. This direction of progress in winding (in the present usage pattern, the X-axis direction) is herein defined as a winding direction of the first peeling sheet 30. The first peeling sheet 30 is further peeled along the winding direction.

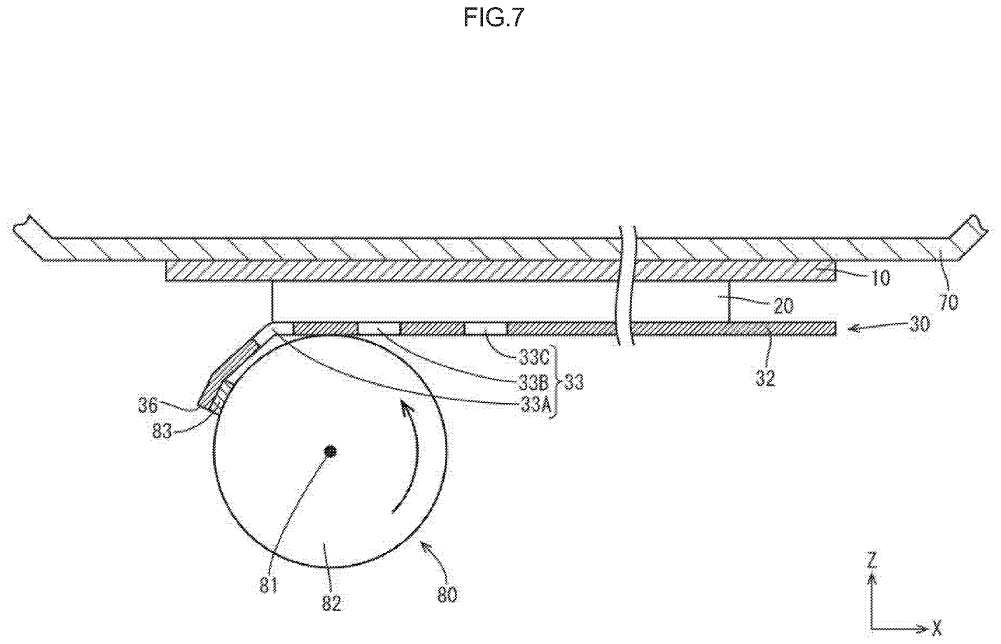

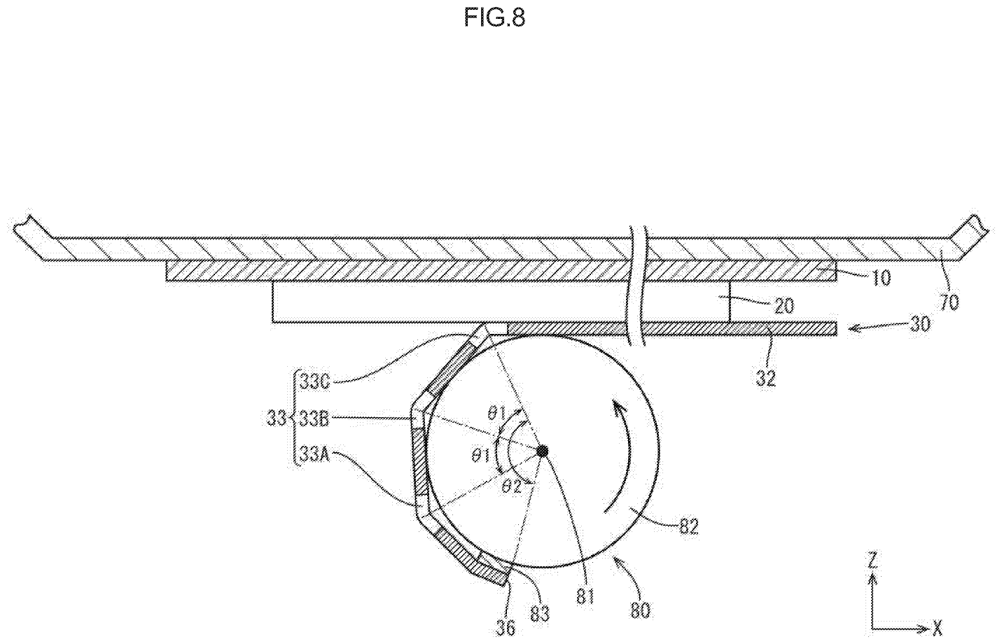

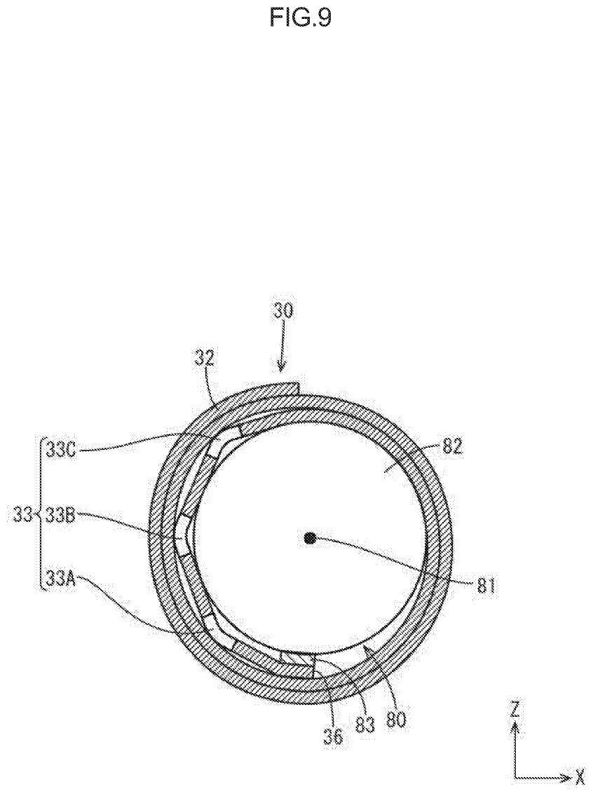

The roller 80 includes a central shaft 81, a cylindrical rotor 82 that rotates on the central shaft 81, and a double-sided tape 83 that extends along an axial direction (i.e. a direction parallel to the central shaft 81) on an outer circumferential surface of the rotor 82. As shown in FIG. 6, the roller 80 causes the double-sided tape 83 to adhere to the vicinity of an end 36 of one long side of the first peeling sheet 30. Next, the central shaft 81 is rotated in a given direction by driving means such as a motor to cause the rotor 82 to rotate counterclockwise. Then, the rotor 82 rotates to move in the X-axis direction while winding the first peeling sheet 30 around the outer circumferential surface of the rotor 82 (FIGS. 7 and 8), and completely winds up the first peeling sheet 30 (FIG. 9).

Incidentally, in a case where the first peeling sheet 30 is high in rigidity and low in bendability, e.g. when the first peeling sheet 30 has a certain degree of thickness, the first peeling sheet 30 does not bend along the outer circumferential surface of the rotor 82 and therefore does not follow the rotation of the roller 80, with the result that the first peeling sheet 30 cannot be wound up. A reduction in thickness of the first peeling sheet 30 brings about improvement in bendability and makes it easy to wind up the first peeling sheet 30. In that case, however, the adhesive layer 20 may suffer from a trace of hitting caused by the rotation of the rotor 82. To address this problem, the first peeling sheet 30 according to the present embodiment is configured such that the formation of the slits 33 along a direction (Y-axis direction) that crosses the winding direction (X-axis direction) causes the first peeling sheet 30 to be wound around the rotor 82 by bending at the slits 33. Moreover, the presence of these slits 33 arranged at intervals along the winding direction causes places of bending by rotation to appear in the order of the slits 33A, 33B, and 33C, so that the first peeling sheet 30 can be bent in such a manner as to follow the rotation of the rotor 82. Furthermore, since, as shown in FIG. 8, the slits 33A, 33B, and 33C are provided at regular intervals in locations at a center angle θ1 in a radial cross-sectional view of the rotor 82, the first peeling sheet 30 can be bent in such a manner as to evenly conform to the outer circumferential surface of the rotor 82.

When the adhesive layer 20 and the first peeling sheet 30 have rectangular shapes, it is harder to bend and wind the first peeling sheet 30 in a case in which the winding direction of the first peeling sheet 30 is a short side direction than in a case in which it is a long side direction. The first peeling sheet 30 according to the present embodiment is configured such that the formation of the slits 33 along a direction (long side direction) that crosses the winding direction (short side direction) and the provision of the slits 33 in pair on both of the pair of short sides of the extended portion 32 make bending improvable even when the winding direction is a short side direction.

Further, at the boundary between the adhesive layer 20, the overlap region 31, and the extended portion 32, which is located below an end of the adhesive layer 20, the first peeling sheet 30 has the greatest repulsive force against peeling and is hard to peel. In the present embodiment, the provision of the slit 33A, which is one of the slits 33, on the extension of this boundary (i.e. on line A-A′ in FIG. 1) brings about improvement in peelability of this part. Furthermore, as shown in FIG. 8, it is preferable that all of the slits 33 (slits 33A, 33B, and 33C) be provided within a range of a half of the outer circumference (a length of ½ of the outer circumference) in the radial cross-sectional view of the rotor 82 from the end 36 of the first peeling sheet 30. That is, it is preferable that all of the slits 33 be provided within an outer circumferential range where a center angle θ2 from the end 36 of the first peeling sheet 30 in the radial cross-sectional view of the rotor 82 is not larger than 180 degrees. With this, all of the slits 33 are concentratedly provided within an outer circumferential range of a half rotation of the rotor 82 from the end 36, which serves as a starting point of winding, of the first peeling sheet 30. This makes it possible to further improve the bendability of the first peeling sheet 30 at the start of winding that corresponds to the first half rotation. The improvement in bendability at the start of winding makes it easier for the first peeling sheet 30 to follow the rotation of the rotor 82 during later winding-up.

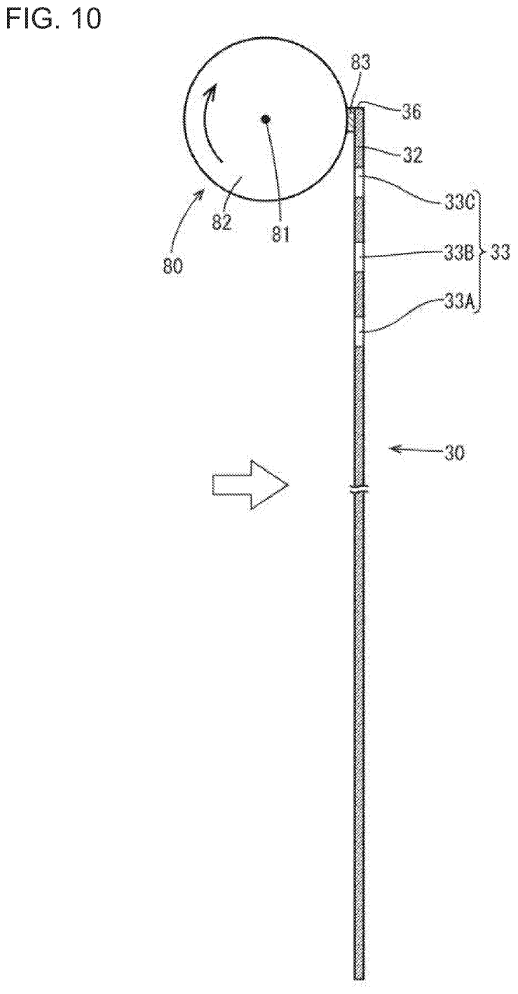

Once the first peeling sheet 30 is thus completely wound up by the rotor 82, the rotor 82 then unwinds the first peeling sheet 30 as shown in FIG. 10 by rotating in a direction opposite to the direction it rotated during winding (in the present usage pattern, clockwise). Then, the first peeling sheet 30 is separated from the roller 80 by being peeled from the double-sided tape 83 by ejection of air blow in the direction of the rightward arrow of FIG. 10. At this time, if the double-sided tape 83 has a high adhesive power, it is hard to separate the first peeling sheet 30. For this reason, it is somewhat difficult to improve the followability of the first peeling sheet 30 with respect to the rotor 82 by increasing the adhesive power of the double-sided tape 83.

Next, the operation of bonding the touch panel 40 to the adhesive layer 20 thus exposed is executed. Once the touch panel 40 is carried in onto the carry-in table 60 as shown in FIG. 11 (operation of carrying in the touch panel 40), the pressure-bonding table 70 comes down onto an upper surface of the touch panel 40 as shown in FIG. 12, so that the lower surface 21 of the adhesive layer 20 is bonded to the upper surface of the touch panel 40 (operation of bonding the touch panel 40 and the adhesive layer 20 together). In so doing, a further enhancement in bondability is attained by pressure bonding with a rotary press 90 rotating along the arrow of FIG. 12.

It should be noted that when the base 10 is smaller in planar size than the first peeling sheet 30, the adhesive sheet 100 is stuck by air suction with the extended portion 32 of the first peeling sheet 30 in direct contact with the pressure-bonding table 70. This may make it hard for the first peeling sheet 30 to be wound around the roller 80 in the next operation of peeling the first peeling sheet 30 (FIG. 5). For the avoidance of this problem, it is preferable that the base 10 be not smaller in planar size than the first peeling sheet 30.

### Other Embodiments

The technology described herein is not limited to the embodiment described above with reference to the drawings. The following embodiments may be included in the technical scope of the technology described herein.

(1) The embodiment described above has illustrated an example in which the base constitutes the second peeling sheet and is formed to be larger in planar size than the adhesive layer for easy peeling. Alternatively, the base does not need to have peelability or be larger in planar size than the adhesive layer.

(2) The embodiment described above has illustrated an example in which the first peeling sheet and the second peeling sheet are made of a resin material such as PET. Alternatively, the first peeling sheet and the second peeling sheet may be made of paper or a composite material including a plurality of materials joined on top of each other.

(3) The embodiment described above has illustrated an example in which the three slits are identical in shape and size to one another. Alternatively, the three slits may be different in shape and size from one another. Further, the number of slits is not limited to three but needs only be two or more.

(4) The embodiment described above has illustrated an example in which the notches and the chamfer are cuts in parts of the outer edge. Alternatively, instead of being cuts, they may be marks for use in positioning and front-back identification.

(5) In the embodiment and usage pattern described above, the touch panel has a planar size of 6.5 inches and the adhesive sheet 100 has a planar size that corresponds to that of the touch panel. However, the technology described herein is also applicable to touch panels and adhesive sheets of other sizes. Further, it is also possible to set the thickness of each layer of the adhesive sheet as appropriate.

1. An adhesive sheet comprising:
a base having a sheet shape;
an adhesive layer disposed on the base; and
a first peeling sheet disposed on a surface of the adhesive layer opposite to the base, wherein
the first peeling sheet is configured to be able to be peeled from the adhesive layer while being wound in a predetermined direction,
the first peeling sheet includes:
an overlap region that overlaps the adhesive layer in a plan view;
an extended portion that sticks out from the overlap region; and
slits in the extended portion, the slits extending in a direction that crosses a winding direction of the first peeling sheet, and
a plurality of the slits are arranged at intervals along the winding direction.

2. The adhesive sheet according to claim 1, wherein the slits are openings bored through the extended portion in a thickness direction.

3. The adhesive sheet according to claim 1, wherein the adhesive layer and the first peeling sheet have rectangular shapes,
the extended portion of the first peeling sheet has a frame shape that surrounds the adhesive layer, and
a pair of the slits are provided on both of a pair of short sides of the extended portion.

4. The adhesive sheet according to claim 1, wherein at least one of the slits is located on an extension of a boundary between the overlap region and the extended portion.

5. The adhesive sheet according to claim 1, wherein the slits are arranged at regular intervals.

6. The adhesive sheet according to claim 1, wherein the first peeling sheet is a peeling sheet that is peeled by being wound around an outer circumference of a cylindrical roller, and
all of the slits are provided within a range of a length of ½ of the outer circumference from an end of the first peeling sheet.

7. The adhesive sheet according to claim 1, wherein the first peeling sheet further includes a notch formed by cutting off a part of an outer edge of the first peeling sheet.

8. The adhesive sheet according to claim 1, wherein the base is a second peeling sheet having peelability.

9. The adhesive sheet according to claim 1, wherein the base is not smaller in planar size than the first peelinq sheet.
